(19) United States
(12) Patent Application Publication
(10) Pub. No.: US 2016/0167232 A1
(43) Pub. Date: Jun. 16, 2016

(54) PLACEMENT DETERMINING METHOD, PLACING METHOD, PLACEMENT DETERMINATION SYSTEM, AND ROBOT

(71) Applicant: TOYOTA JIDOSHA KABUSHIKI KAISHA, Toyota-shi, Aichi-ken (JP)

(72) Inventor: Keisuke TAKESHITA, Toyota-shi (JP)

(73) Assignee: TOYOTA JIDOSHA KABUSHIKI KAISHA, Toyota-shi, Aichi-ken (JP)

(21) Appl. No.: 14/906,753

(22) PCT Filed: Jul. 21, 2014
(86) PCT No.: PCT/IB2014/001609

§ 371 Date: Jan. 21, 2016

(30) Foreign Application Priority Data
Jul. 25, 2013 (JP) 2013-154155

(51) Int. Cl. B25J 9/16; G06K 9/32; G06K 9/00

(52) U.S. Cl. CPC B25J 9/1697; G06K 9/00201; G06K 9/3241; G06K 9/00671; Y10S 901/14; Y10S 901/47; Y10S 901/09; G05B 2219/40053; G05B 2219/37555; G05B 2219/45063

(57) ABSTRACT

A placement determination system (21) includes a placement object specifying unit (22) that specifies a placement object, a resting surface information acquiring unit (24) that obtains the shape of a resting surface of the placement object, a receiving surface information acquiring unit (27) that obtains the shape of a receiving surface of a receiving object on which the placement object is to be placed, and a placement determining unit (28) that compares the shape of the resting surface with the shape of the receiving surface, and determines whether the placement object can be placed on the receiving object.

### BACKGROUND OF THE INVENTION

1. Field of the Invention

The invention relates to a placement determining method, a placing method, a placement determination system, and a robot.

2. Description of Related Art

Robots that execute motions or operations according to external circumstances have been proposed, which include a robot that autonomously moves in a work environment, and a robot that recognizes an object present in a work environment and performs a gripping motion on the object. Japanese Patent Application Publication No. 2003-269937 (JP 2003-269937 A) discloses a robot that detects plane parameters based on a distance image, detects a floor surface using the plane parameters, and recognizes an obstacle using the plane parameters of the floor surface. Japanese Patent Application Publication No. 2004-001122 (JP 2004-001122 A) discloses a robot that obtains three-dimensional information of a work environment, recognizes the position and posture of an object to be gripped which exists in the work environment, and performs a gripping motion on the object to be gripped.

As described above, the robots according to the related art can recognize an obstacle in a work environment, or recognize and grip an object. However, when a placement object, such as a gripped tool, is desired to be placed on a receiving object, such as a workbench, these robots are not configured to determine whether the placement object can be placed on the receiving object. In this respect, a problem may arise, in a life-support robot that moves in household circumstances in which the type of the placement object and the position of an obstacle on the receiving object change frequently.

### SUMMARY OF THE INVENTION

The invention provides a placement determining method, a placing method, a placement determination system, and a robot, which make it possible to determine whether a placement object can be placed on a receiving object.

A placement determining method according to one aspect of the invention includes: specifying a placement object, obtaining a shape of a resting surface of the placement object, obtaining a shape of a receiving surface of a receiving object on which the placement object is to be placed, and comparing the shape of the resting surface with the shape of the receiving surface, and determining whether the placement object can be placed on the receiving object. With this method, it can be determined whether the placement object can be placed on the receiving object, in view of the shape of the placement object.

In the placement determining method as described above, the shape of the receiving surface of the receiving object on which the placement object is to be placed may be obtained by obtaining three-dimensional point group information of the receiving object, detecting a plane from the three-dimensional point group information, and obtaining the shape of the receiving surface from the three-dimensional point group information on the plane. With this method, the plane from which any region where an obstacle is present is excluded can be obtained as the receiving surface.

In the placement determining method as described above, the shape of the resting surface may be compared with the shape of the receiving surface, and it may be determined whether the placement object can be placed on the receiving object, by plotting the shape of the resting surface on a grid so as to obtain grid information of the resting surface, plotting the shape of the receiving surface on a grid so as to obtain grid information of the receiving surface, comparing the grid information of the resting surface with the grid information of the receiving surface, and determining whether the placement object can be placed on the receiving object. With this method, the shape of the resting surface and the shape of the receiving surface can be compared with each other at a high speed.

The placement determining method may further include: specifying a desired placement position on the receiving object, calculating a distance between the plane and the desired placement position, and comparing the distance with a predetermined threshold value. With this method, it can be determined whether the plane on which the placement object is to be placed is the plane on which the object is desired to be placed.

A placing method according to another aspect of the invention includes: determining whether the placement object can be placed on the receiving object, by the placement determining method as described above, and placing the placement object on the receiving object when it is determined that the placement object can be placed on the receiving object. With this method, the placement object that is determined as being able to be placed on the receiving object can be placed on the receiving object.

A placement determination system according to a further aspect of the invention includes: a placement object specifying unit configured to specify a placement object, a resting surface information acquiring unit configured to obtain a shape of a resting surface of the placement object, a receiving surface information acquiring unit configured to obtain a shape of a receiving surface of a receiving object on which the placement object is to be placed, and a placement determining unit configured to compare the shape of the resting surface with the shape of the receiving surface, and determine whether the placement object can be placed on the receiving object. With this arrangement, it can be determined whether the placement object can be placed on the receiving object, in view of the shape of the placement object.

The placement determination system may further include a three-dimensional point group information acquiring unit configured to obtain three-dimensional point group information of the receiving object, and a plane detecting unit configured to detect a plane from the three-dimensional point group information, and the receiving surface information acquiring unit may obtain the shape of the receiving surface from the three-dimensional point group information on the plane. With this arrangement, the plane from which any region where an obstacle is present is excluded can be obtained as the receiving surface.

In the placement determination system as described above, the resting surface information acquiring unit may plot the shape of the resting surface on a grid so as to obtain grid information of the resting surface, while the receiving surface information acquiring unit may plot the shape of the receiving surface on a grid so as to obtain grid information of the receiving surface, and the placement determining unit may compare the grid information of the resting surface with the grid information of the receiving surface, and determine whether the placement object can be placed on the receiving object. With this arrangement, the shape of the resting surface and the shape of the receiving surface can be compared with each other at a high speed.

The placement determination system may further include a desired placement position specifying unit configured to specify a desired placement position on the receiving object, and a placement position determining unit configured to calculate a distance between the plane and the desired placement position, and compare the distance with a predetermined threshold value. With this arrangement, it can be determined whether the plane on which the placement object is to be placed is the plane on which the object is desired to be placed.

A robot according to a still further aspect of the invention includes the placement determination system as described above, and a gripping part that grips the placement object. When the placement determining unit determines that the placement object can be placed on the receiving object, the gripping part places the placement object on the receiving object. With this arrangement, the placement object that is determined as being able to be placed on the receiving object can be Placed on the receiving object.

According to the above aspects of the invention, the placement determining method, placing method, placement determination system, and the robot, which make it possible to determine whether the placement object can be placed on the receiving object, are provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing the relationship among a robot according to a first embodiment of the invention, a placement object, and a receiving object;

FIG. 2 is a view showing the configuration of a placement determination system according to the first embodiment;

FIG. 3 is a flowchart illustrating the procedure of a placement determining method according to the first embodiment;

FIG. 4 is a view showing an example of display screen for specifying the placement object according to the first embodiment;

FIG. 5A is a view showing an example of an icon of the placement object stored in a database according to the first embodiment;

FIG. 5B is a view showing an example of the shape of a resting surface of the placement object according to the first embodiment;

FIG. 6 is a view showing grid information of the resting surface according to the first embodiment;

FIG. 7 is a view showing an image of the receiving object obtained by an image acquiring unit according to the first embodiment;

FIG. 8A is a view showing three-dimensional point group information of the receiving object obtained by a three-dimensional point group information acquiring unit according to the first embodiment, which three-dimensional point group information is obtained from the same viewpoint as that of the image acquiring unit;

FIG. 8B is a view showing three-dimensional point group information of the receiving object obtained by the three-dimensional point group information acquiring unit according to the first embodiment, which three-dimensional point group information is obtained from a different viewpoint from that of the image acquiring unit;

FIG. 9 is a view showing a plane detected by a plane detecting unit according to the first embodiment;

FIG. 10A is a view showing a group of three-dimensional points that constitute a plane taken out by a receiving surface information acquiring unit according to the first embodiment;

FIG. 10B is a view showing grid information of the receiving surface according to the first embodiment;

FIG. 11A is a schematic view showing grid information of the resting surface of the placement object according to the first embodiment;

FIG. 11B is a schematic view showing grid information of the receiving surface according to the first embodiment;

FIG. 11C is a schematic view showing a method of comparing the grid information of the resting surface with the grid information of the receiving surface according to the first embodiment;

FIG. 11D is a schematic view showing the method of comparing the grid information of the resting surface with the grid information of the receiving surface according to the first embodiment;

FIG. 11E is a schematic view showing the method of comparing the grid information of the resting surface with the grid information of the receiving surface according to the first embodiment; and

FIG. 12 is a view showing an image of an available placement position that is visualized and displayed by a placement position output unit according to the first embodiment.

### DETAILED DESCRIPTION OF EMBODIMENTS

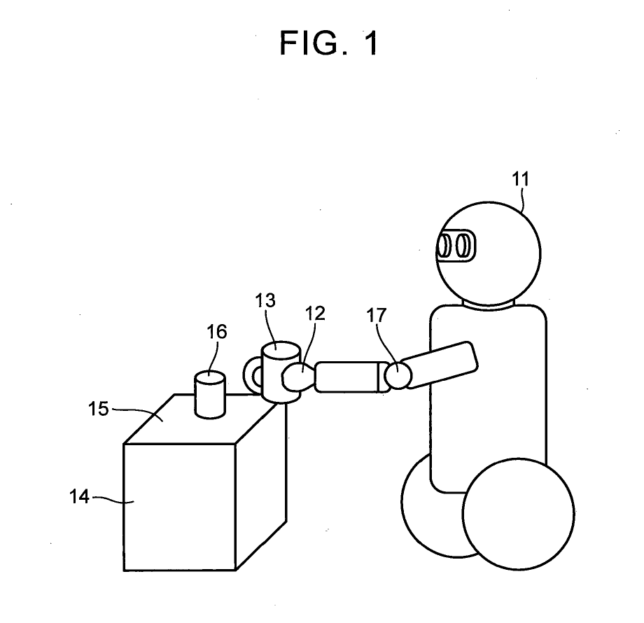

In the following, a first embodiment of the invention will be described with reference to the drawings. FIG. 1 shows the relationship among a robot 11 according to the first embodiment, an object to be placed (which will be called “placement object”), and an object on which the placement object is to be placed (which will be called “receiving object”). The robot 11 incorporates a placement determination system (which is not illustrated in FIG. 1). A gripping part 12 of the robot 11 grips a cup 13 as the placement object. An obstacle 16 is already placed on an upper surface 15 of a table 14 as the receiving object. In this situation, the robot 11 determines whether the cup 13 can be placed on the upper surface 15 of the table 14. Then, the robot 11 has its arm 17 moved to an available placement position on the upper surface 15 of the table 14, and causes the gripping part 12 to release the cup 13, so that the cup 13 is placed at the available placement position.

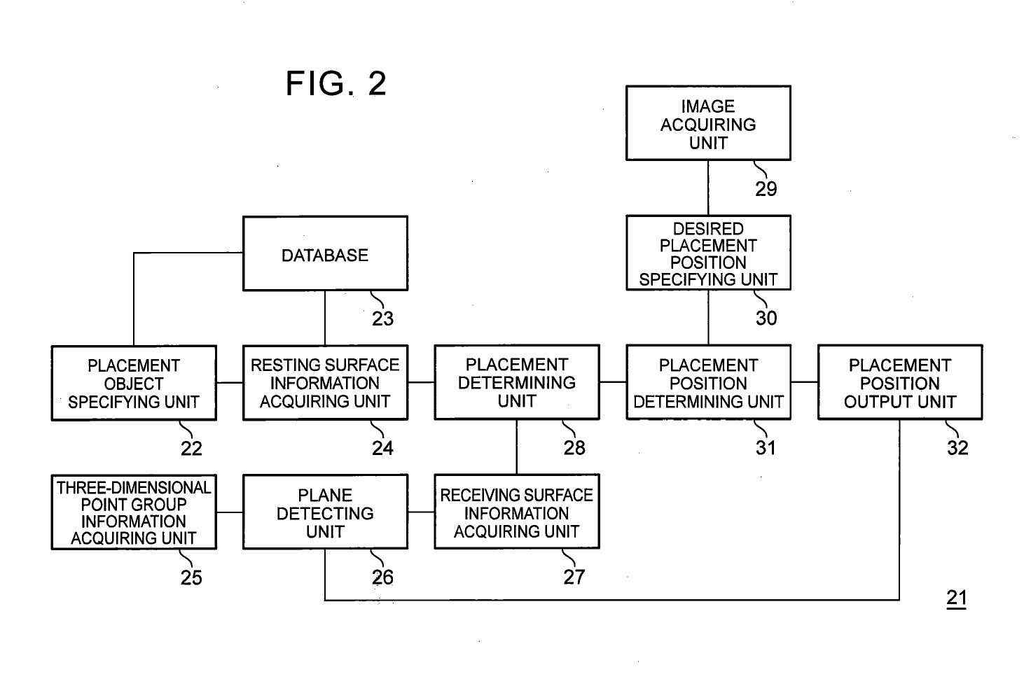

FIG. 2 shows the configuration of the placement determination system 21 according to the first embodiment. The placement determination system 21 includes a placement object specifying unit 22, database 23, resting surface information acquiring unit 24, three-dimensional point group information acquiring unit 25, plane detecting unit 26, receiving surface information acquiring unit 27, placement determining unit 28, image acquiring unit 29, desired placement position specifying unit 30, placement position determining unit 31, and a placement position output unit 32.

The placement object specifying unit 22 specifies the type of the placement object, i.e., the object to be placed on the receiving object. The database 23 stores in advance the shape of the resting surface of the placement object. The resting surface information acquiring unit 24 obtains the shape of the resting surface corresponding to the type of the placement object specified by the placement object specifying unit 22. The three-dimensional point group information acquiring unit 25 obtains three-dimensional point group information of the receiving object. The plane detecting unit 26 detects a plane of the receiving object, using the three-dimensional point group information obtained by the three-dimensional point group information acquiring unit 25. The receiving surface information acquiring unit 27 obtains the shape of the receiving surface from the plane detected by the plane detecting unit 26. The placement determining unit 28 compares the shape of the resting surface obtained by the resting surface information acquiring unit 24 with the shape of the receiving surface obtained by the receiving surface information acquiring unit 27, determines whether the placement object can be placed on the receiving object, and outputs a candidate placement position. The image acquiring unit 29 obtains an image of the receiving object. The desired placement position specifying unit 30 specifies a desired placement position of the placement object on the receiving object, using the image of the receiving object obtained by the image acquiring unit 29. The placement position determining unit 31 calculates a distance between the desired placement position of the placement object specified by the desired placement position specifying unit 30, and the plane of the receiving object detected by the plane detecting unit 26, and compares the distance with a given threshold value. The placement position output unit 32 outputs the candidate placement position received from the placement determining unit 28, as the available placement position, when the distance between the desired placement position and the plane is smaller than the given threshold value.

The resting surface of the placement object refers to an under surface or bottom of the cup 13 in FIG. 1, namely, a surface of the cup 13 which is brought into contact with the upper surface 15 of the table 14. The receiving surface of the receiving object refers to the upper surface 15 of the table 14 in FIG. 1, namely, a surface of the table 14 which is brought into contact with the cup 13.

The constituent elements of the placement determination system 21 are implemented by executing programs, through control of a computing device (not shown) included in the placement determination system 21 as a computer, for example. More specifically, the placement determination system 21 loads a main storage device (not shown) with programs stored in a memory (not shown), and executes the programs through control of the computing device for implementation of the constituent elements. The constituent elements are not limitedly implemented by software using programs, but may be implemented by any combination of hardware, firmware, and software.

The above-described programs may be stored in various types of non-transitory computer-readable media, and supplied to the computer. The non-transitory computer-readable media include various types of tangible storage media. Examples of the non-transitory computer-readable media include magnetic recording media (such as a flexible disc, a magnetic tape, and a hard disc drive), magnetooptical recording media (such as a magnetic optical disc), CD-ROM (read-only memory), CD-R, CD-R/W, and semiconductor memories (such as a mask ROM, PROM (Programmable ROM), EPROM (Erasable PROM), flash ROM, and RAM (random access memory)). The programs may be supplied to the computer via various types of transitory computer-readable media. Examples of the transitory computer-readable media include an electric signal, a light signal, and electromagnetic wave. The transitory computer-readable medium is able to supply programs to the computer, via a wire communication path, such as an electric wire and an optical fiber, or a wireless communication path.

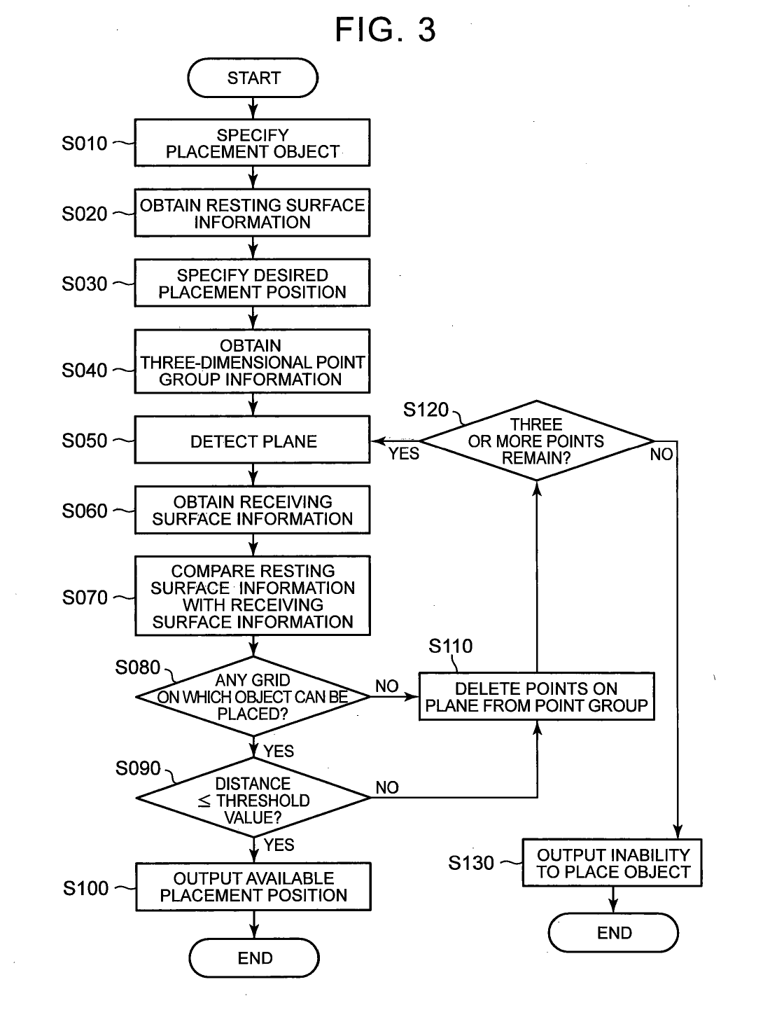

FIG. 3 is a flowchart illustrating the procedure of a placement determining method according to the first embodiment of the invention. Initially, the placement object specifying unit 22 specifies the type of the placement object as the object to be placed on the receiving object (step S010). In this step, an operator (not shown) of the robot 11 designates the placement object, using a display screen for specifying the placement object.

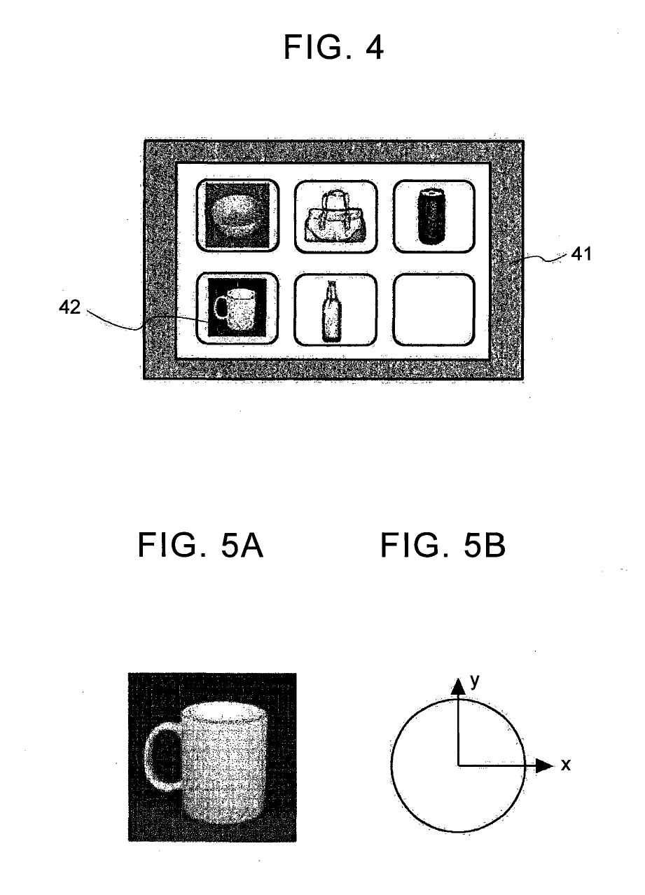

FIG. 4 shows an example of the display screen 41 used for specifying the placement object according to the first embodiment. The display screen 41 for specifying the placement object is displayed on a display located close to the operator of the robot 11. A list of icons representing candidate placement objects is displayed on the display screen 41. These candidate placement objects are stored in advance in the database 23, in association with the icons and the shapes of the resting surfaces thereof. The shapes of two or more candidate resting surfaces for one candidate placement object may be stored in advance in the database 23. The operator of the robot 11 selects the cup 13 gripped by the robot 11, using an icon 42 located at the lower, left position of the display screen. In this manner, the placement object specifying unit 22 can specify the type of the placement object.

Then, the resting surface information acquiring unit 24 obtains the shape of the resting surface corresponding to the placement object specified by the placement object specifying unit 22, from the database 23 (step S020). If there are two or more candidate resting surfaces for the placement object specified by the placement object specifying unit 22, the resting surface information acquiring unit 24 displays the respective shapes of the two or more candidate resting surfaces on the display, and prompts the operator of the robot 11 to select one of the shapes. FIG. 5A and FIG. 5B show an example of the icons of the placement objects stored in the database 23 according to the first embodiment, and an example of the shapes of the resting surfaces of the placement objects stored in the database 23. The resting surface information acquiring unit 24 obtains the shape of the under surface of the cup 13 as shown in FIG. 5B from the database 23, as the shape of the resting surface of the cup 13 as the placement object specified by the placement object specifying unit 22 and shown in FIG. 5A.

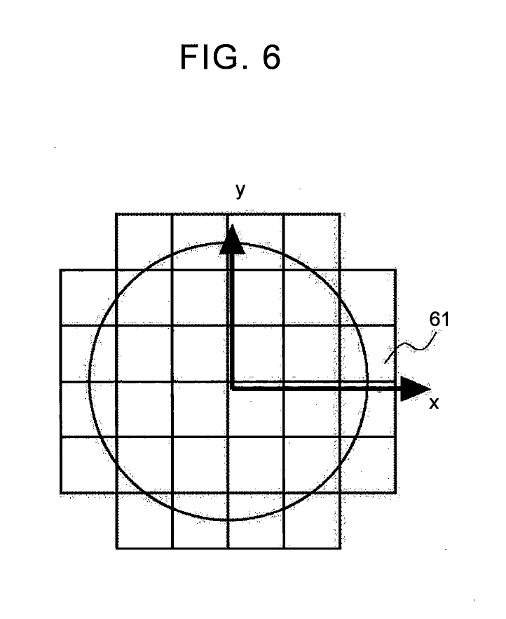

Then, the resting surface information acquiring unit 24 plots the shape of the resting surface on a grid, and obtains grid information of the resting surface. FIG. 6 shows grid information 61 of the resting surface according to the first embodiment. The resting surface information acquiring unit 24 expresses the shape of the under surface of the cup 13 shown in FIG. 5B with a group of squares in the form of a grid, and obtains the grid information 61 of the resting surface.

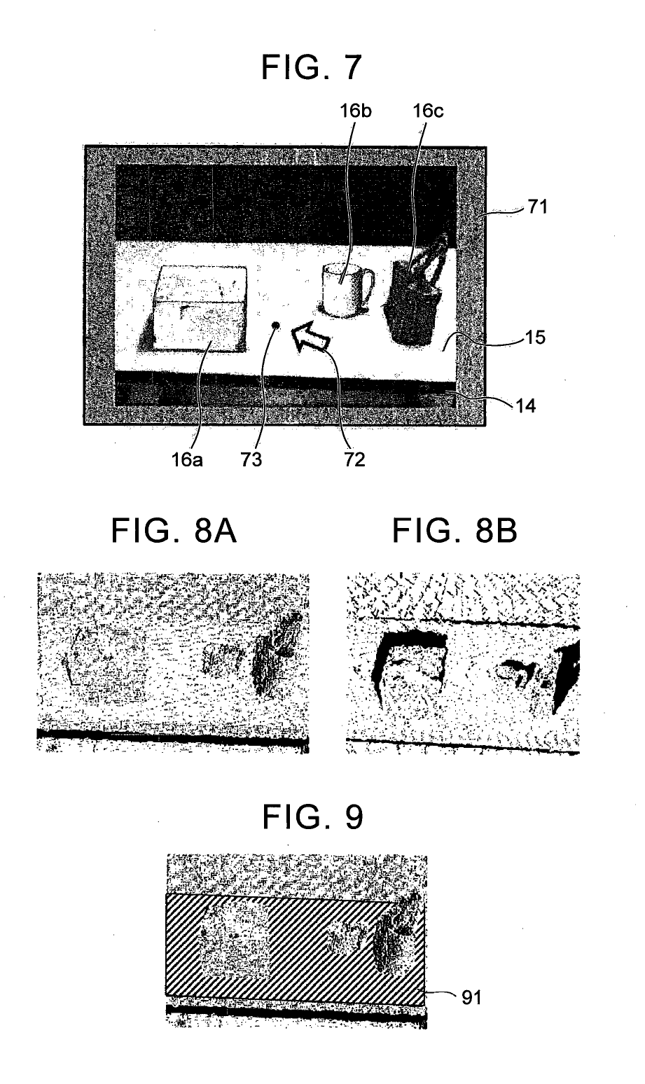

Then, the image acquiring unit 29 obtains an image of the receiving object, i.e., the object on which the placement object is to be placed. FIG. 7 shows an image 71 of the receiving object obtained by the image acquiring unit 29 according to the first embodiment. On the upper surface 15 of the table 14 as the receiving object, obstacles, such as a box 16a, a cup 16b and a handbag 16c, are already placed. The operator of the robot 11 can see the image 71 of the receiving object displayed on the display located close to the operator. Also, the operator of the robot 11 may obtain an image of a desired receiving object, by instructing the image acquiring unit 29 to do so.

Then, the desired placement position specifying unit 30 specifies the desired placement position as a position on the receiving object at which the operator of the robot 11 wants the placement object to be placed (step S030). As shown in FIG. 7, the operator of the robot 11 designates, by use of a pointer 72, the position at which he/she wants the cup 13 to be placed, in the image 71 displayed on the display. In this manner, the desired placement position specifying unit 30 specifies the desired placement position 73.

Then, the three-dimensional point group information acquiring unit 25 obtains three-dimensional point group information of the receiving object, using a sensor(s), such as a laser scanner or two or more cameras (step S040). FIG. 8A and FIG. 8B show three-dimensional point group information of the receiving object obtained by the three-dimensional point group information acquiring unit 25 according to the first embodiment. FIG. 8A shows three-dimensional point group information obtained from the same viewpoint as that of the image acquiring unit 29, namely, from the same viewpoint as that from which the image shown in FIG. 7 is obtained. FIG. 8B shows three-dimensional point group information obtained from a different viewpoint from that of the image acquiring unit 29.

Then, the plane detecting unit 26 detects a plane, from the three-dimensional point group information of the receiving object obtained by the three-dimensional point group information acquiring unit 25 (step S050). FIG. 9 shows the plane detected by the plane detecting unit 26 according to the first embodiment. The plane detecting unit 26 performs plane fitting using the RAMSAC (Random Sample Consensus) method, on the three-dimensional point group information of the receiving object shown in FIG. 8A and FIG. 8B, and detects a wide plane 91 including many three-dimensional points. The detected plane 91 is a plane that excludes regions in which the obstacles 16 are present, from the upper surface 15 of the table 14 as the receiving object.

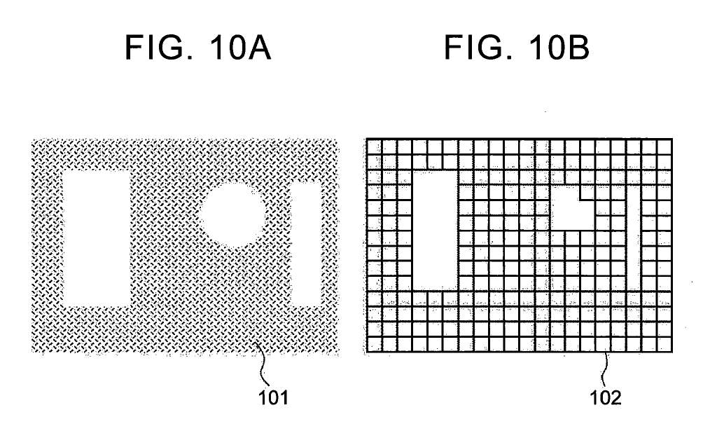

Then, the receiving surface information acquiring unit 27 obtains the shape of the receiving surface from the plane 91 detected by the plane detecting unit 26 (step S060). FIG. 10A shows a group of three-dimensional points that constitute the plane taken out by the receiving surface information acquiring unit 27 according to the first embodiment, when the group of three-dimensional points is viewed from above. FIG. 10B shows grid information of the receiving surface according to the first embodiment. As shown in FIG. 10A, the receiving surface information acquiring unit 27 takes out a three-dimensional point group 101 that constitutes the plane 91 detected by the plane detecting unit 26. Then, the receiving surface information acquiring unit 27 expresses the three-dimensional point group 101 thus taken out, in the form of a group of squares or a grid. If at least one point of the group of three-dimensional points is contained in each of the squares of the grid, the receiving surface information acquiring unit 27 determines the square as an effective cell on the grid, and plots the group of three-dimensional points that constitute the plane, into the form of grid, so as to obtain grid information 102 of the receiving surface as shown in FIG. 10B.

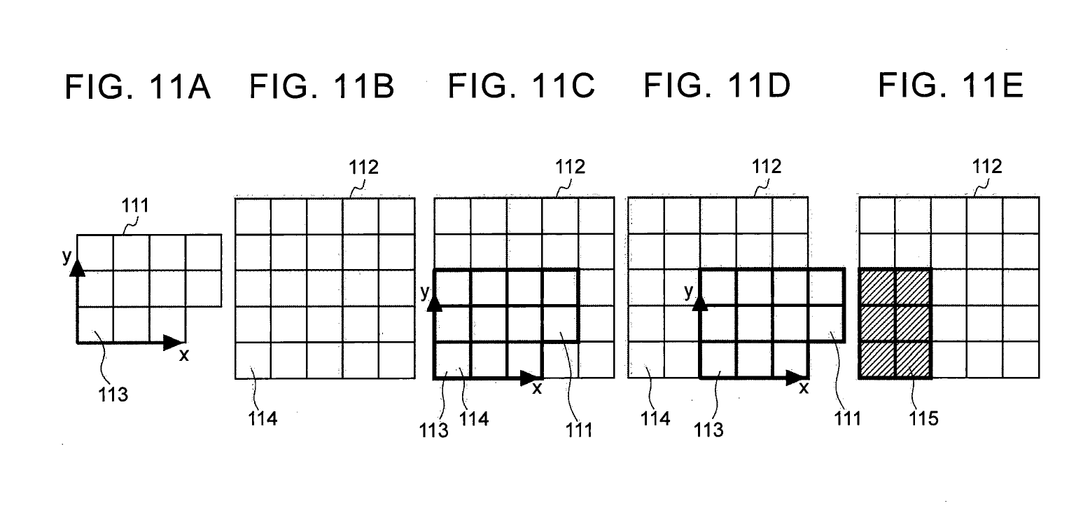

Then, the placement determining unit 28 compares the grid information 61 of the resting surface obtained by the resting surface information acquiring unit 24, with the grid information 102 of the receiving surface obtained, by the receiving surface information acquiring unit 27, and determines whether the placement object can be placed on the receiving object (step S070). FIG. 11A through FIG. 11E schematically show a method of comparing the grid information of the resting surface with the grid information of the receiving surface according to the first embodiment.

The placement determining unit 28 obtains the grid information 111 of the resting surface as shown in FIG. 11A, and the grid information 112 of the receiving surface as shown in FIG. 11B. As shown in FIG. 11A, the lower, left-hand corner of a grid cell 113 located at the leftmost bottom of the grid information 111 of the resting surface is set as the origin, and the right arrow extending from the origin denotes the X direction, while the up-pointing arrow extending from the origin denotes the Y direction.

Then, as shown in FIG. 11C, the placement determining unit 28 superimposes the grid information 111 of the resting surface and the grid information 112 of the receiving surface on each other, so that the position of a grid cell 114 located at the leftmost bottom of the grid information 112 of the receiving surface coincides with the position of the grid cell 113 located at the leftmost bottom of the grid information 111 of the resting surface. At this time, the positions of all grid cells of the grid information 111 of the resting surface coincide with the positions of the corresponding grid cells of the grid information 112 of the receiving surface, as is understood from FIG. 11C. If the positions of all grid cells of the resting surface coincide with the positions of the corresponding grid cells of the receiving surface when the grid information 111 of the resting surface is superimposed on the grid information 112 of the receiving surface, the placement determining unit 28 determines that the placement object can be placed on the receiving object when these objects are positioned relative to each other in this manner.

Then, the placement determining unit 28 shifts the grid information 111 of the resting surface by one grid cell in the X direction, relative to the grid information 112 of the receiving surface, as compared with the arrangement as shown in FIG. 11C, and superimposes the grid information 111 of the resting surface on the grid information 112 of the receiving surface (not illustrated in the drawings). At this time, too, the positions of all grid cells of the resting surface coincide with the positions of the corresponding grid cells of the receiving surface; therefore, the placement determining unit 28 determines that the placement object can be placed on the receiving object where these objects are positioned relative to each other in this manner.

Then, the placement determining unit 28 shifts the grid information 111 of the resting surface by two grid cells in the X direction, relative to the grid information 112 of the receiving surface, as compared with the arrangement as shown in FIG. 11C, and superimposes the grid information 111 of the resting surface on the grid information 112 of the receiving surface, as shown in FIG. 11D. At this time, as shown in FIG. 11D, two grid cells at the right-hand end of the grid information 111 of the resting surface are not contained in the grid represented by the grid information 112 of the receiving surface. Thus, when one or more grid cells as a part of the resting surface is/are not contained in the grid represented by the grid information 112 of the receiving surface, the placement determining unit 28 determines that the placement object cannot be placed on the receiving object when these objects are positioned relative to each other in this manner.

Similarly, the placement determining unit 28 repeatedly shifts the grid information 111 of the resting surface by one grid cell in the X direction, relative to the grid information 112 of the receiving surface, as compared with the arrangement as shown in FIG. 11C, and superimposes the grid information 111 of the resting surface on the grid information 112 of the receiving surface. Then, the placement determining unit 28 determines whether the placement object can be placed on the receiving object at the respective positions.

Also, the placement determining unit 28 repeatedly shifts the grid information 111 of the resting surface by one or more grid cells in the X direction and/or the Y direction, relative to the grid information 112 of the receiving surface, as compared with the arrangement as shown in FIG. 11C, and superimposes the grid information 111 of the resting surface on the grid information 112 of the receiving surface. Then, the placement determining unit 28 determines whether the placement object can be placed on the receiving object at the respective positions.

Then, the placement determining unit 28 obtains a result of determination that the placement object can be placed on the receiving object when the grid cell 113 located at the leftmost bottom of the grid information 111 of the resting surface is located at the position of any of six grid cells 115 in a left, lower region of the grid information 112 of the receiving surface as shown in FIG. 11E.

Then, the placement determining unit 28 determines whether there is any grid based on which it can be determined that the placement object can be placed on the receiving surface (step S080). If the placement determining unit 28 determines that there is at least one grid based on which it can be determined that the placement object can be placed on the receiving surface (YES in step S080), the placement determining unit 28 outputs the grid as a candidate placement position.

Then, the placement position determining unit 31 calculates the distance between the plane 91 detected by the plane detecting unit 26 in step S050, and the desired placement position 73 specified by the desired placement position specifying unit 30 in step S030, and determines whether the calculated distance is equal to or smaller than a given threshold value (step S090).

Then, when the placement position determining unit 31 determines that the distance between the plane 91 and the desired placement position 73 is equal to or smaller than the given threshold value (YES in step S090), the placement position output unit 32 determines that the plane 91 in which the grid as the candidate placement position received from the placement determining unit 28 exists is the receiving surface of the receiving object on which the desired placement position 73 exists. As described above, the desired placement position is the position in the receiving object at which the operator of the robot 11 wants the placement object to be placed. Then, the placement position output unit 32 outputs the candidate placement position received from the placement determining unit 28, as an available placement position (step S100), and finishes the routine of FIG. 3.

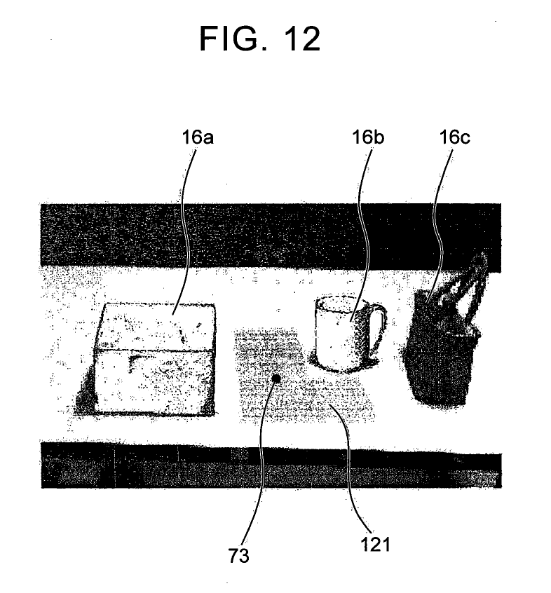

FIG. 12 shows an image in which the available placement position 121 is visualized and displayed by the placement position output unit 32 according to the first embodiment. In FIG. 12, the image representing the available placement position 121 is visualized and displayed by the placement position output unit 32, on the image of the table as the receiving object as shown in FIG. 7. In FIG. 12, the available placement position 121 is displayed, in the vicinity of the desired placement position 73 designated by the operator of the robot 11 in step S030 as the position at which he/she wants the cup 13 to be placed. Then, the robot 11 moves the arm 17 to the available placement position 121 while avoiding the obstacles 16a, 16b, 16c, and causes the gripping part 12 to release the cup 13, so as to place the cup 13 at the available placement position 121.

If the placement determining unit 28 determines that there is no grid based on which it can be determined that the placement object can be placed on the receiving surface (NO in step S080), the placement position determining unit 31 deletes information of the group of three-dimensional points that constitute the plane taken out by the receiving surface information acquiring unit 27, from the three-dimensional point group information of the receiving object obtained by the three-dimensional point group information acquiring unit 25 (step S110).

If the placement position determining unit 31 determines that the distance between the plane 91 and the desired placement position 73 is larger than the given threshold value (NO in step S090), the placement position determining unit 31 deletes the information of the group of three-dimensional points that constitute the plane taken out by the receiving surface information acquiring unit 27, from the three-dimensional point group information of the receiving object obtained by the three-dimensional point group information acquiring unit 25.

Then, the placement position determining unit 31 determines whether a three-dimensional point group consisting of three or more points remains in the three-dimensional point group information of the receiving object, as a result of deleting the information of the group of three-dimensional points that constitute the plane taken out by the receiving surface information acquiring unit 27, from the three-dimensional point group information of the receiving object obtained by the three-dimensional point group information acquiring unit 25 (step S120).

When the placement position determining unit 31 determines that the three-dimensional point group consisting of three or more points remains (YES in step S120), it transmits the three-dimensional point group information of the remaining three-dimensional points to the plane detecting unit 26, which in turn executes step S050 to detect a plane again. Then, subsequent steps are executed. If the three-dimensional. point group consisting of three or more points remains, the plane detecting unit 26 can detect a plane different from the plane detected in step S050 of the last cycle, and the receiving surface information acquiring unit 27 can obtain the shape of a receiving surface which is different from the shape of the receiving surface obtained in step S060 of the last cycle.

If, on the other hand, the placement position determining unit 31 determines that no three-dimensional point group consisting of three or more points remains (NO in step S120), it determines that no receiving surface on which the placement object is placed can be detected from the receiving object, namely, the placement object cannot be placed on the receiving object. In this case, the placement position determining unit 31 displays a notification that informs the operator of the inability to place the placement object on the receiving object, on the display located in the vicinity of the operator (step S130), and finishes the routine of FIG. 3.

As described above, the robot 11 according to the first embodiment includes the placement object specifying unit 22 that specifies the placement object, the resting surface information acquiring unit 24 that obtains the shape of the resting surface of the placement object, the receiving surface information acquiring unit 27 that obtains the shape of the receiving surface of the receiving object on which the placement object is placed, and the placement determining unit 28 that compares the shape of the resting surface with the shape of the receiving surface, and determines whether the placement object can be placed on the receiving object. When the placement determining unit 28 determines that the placement object can be placed on the receiving object, the robot 11 causes the gripping part 12 that grips the placement object to place the placement object on the receiving object. Thus, it can be determined whether the placement object can be placed on the receiving object, in view of the shape of the placement object.

Also, the robot 11 according to the first embodiment includes the three-dimensional point group information acquiring unit 25 that obtains three-dimensional point group information of the receiving object, and the plane detecting unit 26 that detects a plane from the three-dimensional point group information. The receiving surface information acquiring unit 27 obtains the shape of the receiving surface from the three-dimensional point group information on the plane. Thus, the receiving surface information acquiring unit 27 can obtain the plane from which the region where the obstacle 16 is present is excluded, as the receiving surface.

Also, in the robot 11 according to the first embodiment, the resting surface information acquiring unit 24 plots the shape of the resting surface on a grid, so as to obtain grid information of the resting surface, and the receiving surface information acquiring unit 27 plots the shape of the receiving surface on a grid, so as to obtain grid information of the receiving surface. Then, the placement determining unit 28 compares the grid information of the resting surface with the grid information of the receiving surface, and determines whether the placement object can be placed on the receiving object. In this manner, it is possible to compare the shape of the resting surface with the shape of the receiving surface at a high speed.

Also, the robot 11 according to the first embodiment further includes the desired placement position specifying unit 30 that specifies the desired placement position on the receiving object, and the placement position determining unit 31 that calculates the distance between the plane detected by the plane detecting unit 26 and the desired placement position, and compares the distance with the given threshold value. Thus, it is possible to determine whether the plane on which the placement object is to be placed is the same as the plane on which the operator wants the placement object to be placed.

It is to be understood that the present invention is not limited to the above-described first embodiment, but the above embodiment may be modified as needed without departing from the principle of the invention.

In the first embodiment, when the placement object specifying unit 22 specifies the type of the placement object in step S010, the operator of the robot 11 designates the placement object, using the icons on the display screen for specifying the placement object. However, the operator of the robot 11 may enter the name or ID of the placement object, using a CUI (character user interface).

In the first embodiment of the invention, in step S030, the desired placement position specifying unit 30 specifies the desired placement position as the position at which the placement object is desired to be placed, on the receiving object, using the image 71 of the receiving object obtained by the image acquiring unit 29. However, the operator of the robot 11 may directly enter, the coordinates of the desired placement position, using the CUI.

In the first embodiment of the invention, in step S070, the placement determining unit 28 compares the grid information 61 of the resting surface of the placement object with the grid information 102 of the receiving surface, and determines whether the placement object can be placed on the receiving object. However, the placement determining unit 28 may directly compare the shape of the resting surface with the shape of the receiving surface, and determine whether the placement object can be placed on the receiving object.

In the first embodiment of the invention, in step S090, the placement position determining unit 31 calculates the distance between the plane 91 detected by the plane detecting unit 26 and the desired placement position 73, and determines whether the distance thus calculated is equal to or smaller than the given threshold value. However, the placement position determining unit 31 may calculate the distance between the plane 91 and the desired placement position 73, immediately after the plane detecting unit 26 detects the plane 91 in step S050, and determine whether the distance thus calculated is equal to or smaller than the given threshold value.

In the first embodiment of the invention, in step S100, the placement position output unit 32 visualizes and displays each of the positions where the placement object can be placed, on the image of the table as the receiving object. However, the position, posture, and size of the grid representing the position at which the placement object can be placed may be displayed on the CUI.

While the placement determination system 21 is incorporated in the robot 11 in the first embodiment of the invention, the displacement determination system 21 may be configured as a system that is divided into two or more devices including the robot 11, such that the devices fulfill respective functions in the system.

1. A placement determining method, comprising:
specifying a placement object;
obtaining a shape of a resting surface of the placement object;
obtaining a shape of a receiving surface of a receiving object on which the placement object is to be placed; and
comparing the shape of the resting surface with the shape of the receiving surface, and determining whether the placement object can be placed on the receiving object.

2. The placement determining method according to claim 1, wherein
the shape of the receiving surface of the receiving object on which the placement object is to be placed is obtained by obtaining three-dimensional point group information of the receiving object, detecting a plane from the three-dimensional point group information, and obtaining the shape of the receiving surface from the three-dimensional point group information on the plane.

3. The placement determining method according to claim 1, wherein
the shape of the resting surface is compared with the shape of the receiving surface, and it is determined whether the placement object can be placed on the receiving object, by plotting the shape of the resting surface on a grid so as to obtain grid information of the resting surface, plotting the shape of the receiving surface on a grid so as to obtain grid information of the receiving surface, comparing the grid information of the resting surface with the grid information of the receiving surface, and determining whether the placement object can be placed on the receiving object.

4. The placement determining method according to claim 2, further comprising:
specifying a desired placement position on the receiving object;
calculating a distance between the plane and the desired placement position; and
comparing the distance with a predetermined threshold value.

5. A placing method comprising:
determining whether the placement object can be placed on the receiving object, by the placement determining method according to claim 1; and
placing the placement object on the receiving object when it is determined that the placement object can be placed on the receiving object.

6. A placement determination system comprising:
a placement object specifying unit configured to specify a placement object;
a resting surface information acquiring unit configured to obtain a shape of a resting surface of the placement object;
a receiving surface information acquiring unit configured to obtain a shape of a receiving surface of a receiving object on which the placement object is to be placed; and
a placement determining unit configured to compare the shape of the resting surface with the shape of the receiving surface, and determine whether the placement object can be placed on the receiving object.

7. The placement determination system according to claim 6, further comprising:
a three-dimensional point group information acquiring unit configured to obtain three-dimensional point group information of the receiving object; and
a plane detecting unit configured to detect a plane from the three-dimensional point group information, wherein
the receiving surface information acquiring unit obtains the shape of the receiving surface from the three-dimensional point group information on the plane.

8. The placement determination system according to claim 6, wherein:
the resting surface information acquiring unit plots the shape of the resting surface on a grid so as to obtain grid information of the resting surface;
the receiving surface information acquiring unit plots the shape of the receiving surface on a grid so as to obtain grid information of the receiving surface; and
the placement determining unit compares the grid information of the resting surface with the grid information of the receiving surface, and determines whether the placement object can be placed on the receiving object.

9. The placement determination system according to claim 7, further comprising:
a desired placement position specifying unit configured to specify a desired placement position on the receiving object; and
a placement position determining unit configured to calculate a distance between the plane and the desired placement position, and compare the distance with a predetermined threshold value.

10. A robot comprising:
the placement determination system according to claim 6; and
a gripping part that grips the placement object, wherein
when the placement determining unit determines that the placement object can be placed on the receiving object, the gripping part places the placement object on the receiving object.
